(19) United States
(12) Patent Application Publication
(10) Pub. No.: US 2008/0018018 A1
(43) Pub. Date: Jan. 24, 2008

(54) Solid freeform fabrication methods and systems

(76) Inventors: Jeffrey A. Nielsen, Corvallis, OR (US); John A. Devos, Corvallis, OR (US); Isaac Farr, Corvallis, OR (US); Tony S. Cruz-Uribe, Corvallis, OR (US); Terry M. Lambright, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/490,567

(22) Filed: Jul. 20, 2006

(51) Int. Cl. B29C 41/02

(52) U.S. Cl. 264/308; 425/375; 425/447; 700/119

(57) ABSTRACT

A solid freeform fabrication system includes a powdered build material deposited as a layer in a fabrication bin; a binding powder deposited as a layer over the layer of powdered build material; and an activating fluid that is selectively dispensed from an ejection head to activate the binding powder. The activated binding powder then selectively binds the build material into a cross-section of an object being fabricated.

### BACKGROUND

Solid freeform fabrication (SFF) is a process whereby three-dimensional objects, for example, prototype parts, models, working tools, production parts, molds, and other objects are manufactured by sequentially depositing or solidifying layers of a structural material based on electronic data that defines the object to be fabricated. Computer aided design (CAD) is commonly used to produce the data defining the object being fabricated and to automate the production process. Using a suitable computer and a solid freeform fabrication system, an operator may design a three-dimensional object and then create a physical incarnation of that object. The efficient production of prototype three-dimensional compositions or objects can reduce the time it takes to bring a product to market at a reasonable cost.

Various techniques of solid freeform fabrication have been explored. For example, in stereolithography, a laser is used to selectively solidify a liquid build material, layer by layer. In other methods of solid freeform fabrication a positionable ejection head is used to selectively deposit the structural build material of the object being fabricated.

In more recently developed solid freeform fabrication techniques, an ejection head is used to selectively deposit a liquid binder into a build material that is typically in the form of a powder or slurry. This process forms one cross-section of the desired object at a time and is repeated for each layer of the object being formed. The ejection head in such systems may include, for example, a thermal, piezoelectric, or continuous inkjet system.

These arrangements, however, limit the types of materials that can be used in the binder of the solid freeform fabrication system to materials that can be selectively and efficiently jetted from the ejection head. Materials that have too high a viscosity or surface tension or materials with relatively high molecular weights may be precluded from use in the binder because such materials are not readily dispensed with an ejection head.

### SUMMARY

A solid freeform fabrication system includes a powdered build material deposited as a layer in a fabrication bin; a binding powder deposited as a layer over the layer of powdered build material; and an activating fluid that is selectively dispensed from an ejection head to activate the binding powder. The activated binding powder then selectively binds the build material into a cross-section of an object being fabricated.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a top view of the principal components and operational zones of an exemplary system according to principles described herein.

FIGS. 2A-2F show vertical cross-sectional views of various steps in a solid freeform fabrication process according to principles described herein.

FIG. 2A shows the arrival of successive drops of activation liquid with the first drop entering the binding powder layer.

FIG. 2B shows dissolution of corresponding portions of the binder layer and penetration of the base layer.

FIG. 2C shows complete dissolution of the binder layer and penetration of the base layer in selected locations.

FIG. 2D shows a bound section of the base layer, i.e., a cross-section of the object being formed.

FIG. 2E shows a subsequent build material layer and binder layer which have been deposited.

FIG. 2F shows portions of two build material layers bound together.

FIGS. 3A-3E show vertical cross-sectional views of the various stages of a solid freeform fabrication process according to principles described herein.

FIG. 3A shows a view in which a first layer of build material powder has been deposited.

FIG. 3B shows a view in which a first layer of binding powder with anchor particles has been deposited.

FIG. 3C shows a view in which the first layer of binding powder has been dissolved.

FIG. 3D shows a view in which a second layer of build material powder has been deposited.

FIG. 3E shows a view in which a second layer of binding powder has been deposited.

Throughout the drawings, identical reference numbers designate similar, but not necessarily identical, elements.

### DETAILED DESCRIPTION

Methods and apparatus for the solid freeform fabrication of objects defined by electronic data are described herein. In some examples, a layer of binding powder is deposited over a layer of powdered build material. A fluid is selectively dispensed by an ejection head to selectively activate the binding powder which then penetrates the underlying layer of powdered build material to selectively bind portions of the build material layer into a portion of the object being formed.

As used in the present specification and in the appended claims, the term “binder” or “binding powder” is meant to be understood broadly as any material used to bind separate particles together or facilitate adhesion to a surface. The term “powdered build material,” “build material” or “build material powder” refers broadly to any material that can be used to form the bulk of the object being fabricated. The term “anchor particles” is meant to be understood broadly as any particles that extend between structural layers of the object being formed to provide added mechanical strength.

In the following description, for purposes of explanation, numerous specific details are set forth in order to provide a thorough understanding of the present systems and methods for the solid freeform fabrication of desired objects. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Exemplary System

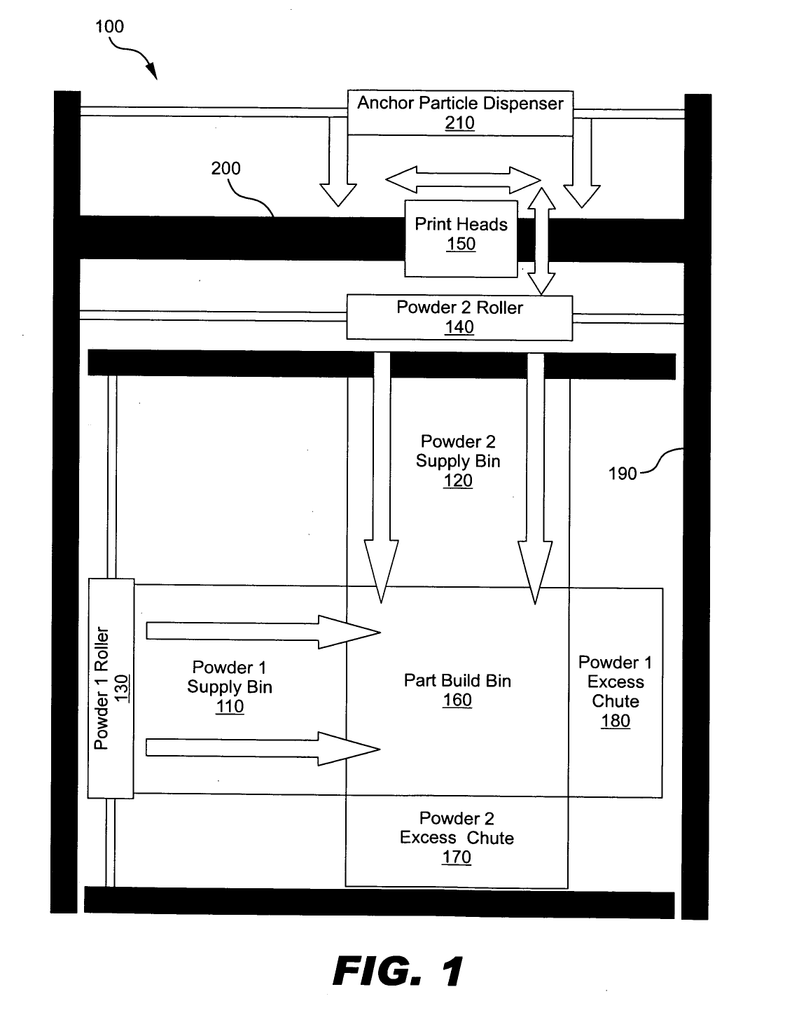

FIG. 1 illustrates a solid freeform fabrication system according to the principles described herein. In the solid freeform fabrication system (100) of FIG. 1, a powdered build material is used to form each individual layer of the desired object.

A measured quantity of powdered build material is first provided from a supply chamber. A roller or spreader incorporated into a moving stage distributes and compresses the build material powder at the top of a fabrication chamber into a layer of a desired, generally-uniform thickness. As will be described in more detail below, the same or a different moving stage then distributes a layer of binding powder over the layer of powdered build material.

Then, the dispensing member or ejection head, which may also be incorporated into the moving stage, selectively deposits an activation liquid into the top layer of binding powder in the fabrication chamber. The activation liquid is dispensed in a two dimensional pattern that represents a cross-section of the desired object being fabricated. The ejection head may also eject ink, toner or color activator into the layers of powder to provide a desired color or color pattern for each cross-section of the desired object. The ejection head may comprise multiple dispensers, printheads or nozzles to achieve local composition control within each layer.

The activation liquid will activate the binding properties of the binding powder and cause the activated binding powder to penetrate into the underlying layer of powdered build material. In some examples, the activation liquid will dissolve the binding powder and wash the binding powder into the powdered build material in those areas where the activation liquid has been applied.

The powdered build material then becomes bonded in the areas where the activation liquid is deposited, thereby forming a layer or cross-section of the object being fabricated. This process is repeated with new layers of powdered build material and binding powder being applied over the top of the previous layers in the fabrication chamber. The next cross-section of the desired product is then fabricated by again selectively dispensing activation liquid as described above.

In some examples, the ejection head will also heat the activation liquid to enhance the reaction between the activation fluid and the binding powder, e.g., dissolution of the binding powder and/or washing the binding powder into the build material. For example, the ejection head may heat the activation liquid to at least 70° Celsius.

This process continues until the entire object is formed within the fabrication chamber. The extra powder that is not bonded is then brushed away leaving the desired object. A user interface or control panel is provided to allow the user to control the fabrication process.

As noted above, the ejection head in the solid freeform fabrication system (100) often includes inkjet technology, such as drop-on-demand technology, for dispensing activation liquid and, in some examples, colored ink into the layers of the object being formed. As used herein and in the attached claims, the term “ink” is used broadly to mean any substance ejected by a dispensing member to color an object being fabricated. Consequently, the term “ink” includes, but is not limited to, ink, printing fluid, toner, colorant, binder, etc.

To provide a variety of colors to objects produced via solid freeform fabrication, two-dimensional printing techniques are typically employed with a plurality of dispensing members. Principles such as half-toning, dithering and color mixing can be used in solid freeform fabrication to provide many apparent colors from relatively few colors of ink released from the ejection head. The apparent color is the color that is seen by an observer viewing the three-dimensional object.

As shown in FIG. 1, a solid freeform fabrication system according to principles described herein may include a first powder supply bin (110), which cooperates with a first powder roller (130). The powder stored in, and dispensed from, the first supply bin (110) can be either the powdered build material or the binding powder described above. For purposes of the example of FIG. 1, it will be assumed that the powdered build material is stored in the first supply bin (110) and dispensed with the first powder roller (130).

The system of FIG. 1 also includes a second powder supply bin (120), which cooperates with a second powder roller (140). In operation, the second powder supply bin (120) may contain either the powdered build material or the binding powder. For purposes of the example of FIG. 1, the second powder supply bin (120) contains the binding powder which is dispensed over each layer of powdered build material as described above. The rollers (130, 140) deposit respective layers of powder in a fabrication bin or part build bin (160), as shown in FIG. 1. Any excess powder goes respectively into a first excess powder chute (180) or a second excess powder chute (170) adjacent to the part build bin (160).

An ejection head (150), which includes, for example, inkjet print heads, is used to apply the activating fluid as described above. The ejection head (150) slides along a boom (200) which, in turn, slides along longitudinal tracks (190). This motion allows the ejection head (150) to move over the entire area of the part build bin (160) in order to apply the activating fluid at every location in the part build bin (160).

In some embodiments, described further below, an additional powder dispenser (210) can be used to selectively apply an additional powder, such as a layer of anchor particles. These anchor particles are used to increase the mechanical strength of the object being formed by providing structural elements that run between adjacent layers of the object being fabricated. The system of FIG. 1 may be operated by computer control.

As noted above, the first powder supply bin (110) contains a store of a powdered build material and is communicably connected to first powder roller (130). First powder roller (130) slides forward (from left to right in FIG. 1) to deposit a layer of predetermined thickness of the powdered build material in the part build bin (160).

The powdered build material can comprise or be selected from materials useful as a build material for solid freeform fabrication, including, but not limited to, nanocomposites such as PEO/clay, closite 10A, closite 30B, closite Na+, hydrophilic polymer silicates, hydroxyapatites, and layered double hydroxides (LDHs); fibrous materials such as polypropylene polyimides, and glass; cellulosics; inorganics such as glass, ceramics, aluminum, and zirconium; metals such as steel, gold, and copper; preformed plastic granules such as polystyrene polymethacrylates, other polymers, epoxies, and combinations thereof. In some embodiments, the particles of powdered build material are relatively inert particles such as polished metal or glass that have been modified, such as with a surface treatment, to make them more wettable or more reactive with the activated binding material.

The powdered build material may also include fillers to stiffen, smooth, or otherwise alter the surface of the solid freeform object. The fillers can include organic fillers and inorganic fillers. The organic fillers can include, but are not limited to, methacrylates (e.g., polymethylmethacrylate and polyhydroxyethylmethacrylate), polybutad iene styrene copolymers, maleic anhydride co-polymers, starch, starch derivatives, cellulose, cellulose derivatives, polycarbonates, polyepoxides, polyacrylates, polymethacryaltes, polyethylene and combinations thereof. The inorganic fillers can include, but are not limited to, fumed silica, hydroxyapatite, layered double hydroxides, organic-inorganic clays ceramics, glasses, naturally occurring materials and their synthetic derivatives, polymer fillers, sand, quartz, silicon dioxide, aluminum oxide, titanium dioxide, aluminum hydroxide, nitrides (e.g. silicon nitride), kaolin, talc, wollstonite, feldspar, mica, zinc glass, boron silicate glass, and combinations thereof.

The second powder supply bin (120) comprises a store of binding powder and is communicably connected to the second powder roller (140). Second powder roller (140) next slides forward (from top to bottom in FIG. 1) to deposit a layer of predetermined thickness of binding powder on top of the layer of powdered build material in the part build bin (160).

As described above, the binding powder has the ability to bind together the build material into a solid object when combined with, or activated by, an activation liquid. The binding powder may be or include, for example, high and/or low molecular weight homo- and co-polymers of polyvinyl pyrrolidone, polysaccharides, (e.g., pullulan, chitosan, carrageenan, acacia, polyalginic acid, xantham gums), cellulose derivatives (e.g., methyl cellulose, hydroxypropylmethylcellulose and hydroxyethylcellulose), homo- and co-polymers of polyacids (e.g., polyacrylic acid, polymethacrylic acid, polyvinylacetic acid, polyitaconic acid, polystyrenesulfonic acid, polyvinyl sulfate, polyvinylphosphonic acid and polymaleic acid), natural or chemically modified starches (e.g., potato, wheat, corn, rice or tapioca), polyacrylamides, polyformamides, polyacetamides, polyoxazolidones, polyethylene glycol, polyethylene oxide, poly(2-ethyl-2-oxazoline); sugars (e.g., sucrose, dextrose, fructose, lactose, polydextrose, sorbitol and xylitol); and organic compounds (e.g., citric acid and succinic acid); inorganics (e.g., sulfates, phosphates, bentonite, silicates). The binding powder may also comprise additional materials useful to control the object properties such as reaction accelerators/retarders, strengthening agents, pre-formed nanocomposites, pH modifiers, viscosity modifiers, multivalent cations for crosslinking purposes, acrylates, reducing agents, oxidizing agents, and light sensitive initiators.

The pH modifier may include, but are in no way limited to one or more of the following: tartaric acid, citric acid, glutamic acid, diglycolic acid, DL aspartic acid, iminodiacetic acid, itaconic acid, and NH₄H₂PO₄. The retardant can include, but is not limited to, sodium phosphate, potassium phosphate, potassium oxalate, sodium oxalate, sodium carbonate, potassium carbonate, salicylic acid, tartaric acid, dihydroxytartaric acid, oxalic acid, citric acid, ethylenediamine tetraacetic acid (EDTA) and their sodium and potassium salts, sodium phosphate, sodium dihydrogen phosphate as well as sodium hydrogen phosphate, magnesium oxide and tin fluoride and combinations thereof. The accelerator can form compounds such as, but not limited to, Al3+ compounds (e.g., Al(NO₃)₃, Al₂(PO₄)₃, and Al₂(SO₄)₃) and Zn₂+ compounds (e.g., ZnO, Zn(NO₃)₂, and Zn(SO₄)). The wetting agent can include, but is not limited to, tergitols, ethylene glycols, and fluorosurfactants, and combinations thereof. The viscosity modifier can include, but is not limited to, ethanol, hexanediol, pentanediol, ethylene glycol diacetate, potassium aluminum sulphate, isopropanol, ethylene glycol monobutyl ether, diethylene monobutyl ether, dodecyldimethylammonium proposane sulphonate, glycerine triacetate, ethyl acetoacetate, polyvinyl pyrrolidone, polyethylene glycol, polyacrylic acid, sodium polyacrylate, and combinations thereof. The surface tension modifier can include, but is not limited to, ethanol, hexanediol, pentanediol, tergitols, ethylene glycols, fluorosurfactants, and combinations thereof. Strengthening agents can include materials such as fibers. Fibers can include, but are not limited to, polymer fibers, ceramic fibers, natural fibers, carbon fibers, glass fibers, and combinations thereof. More specifically, the fibers can include, but are not limited to, cellulose fibers, wood fibers, polypropylene fibers, aramide fibers, silicon carbide fibers, aluminum silicate fibers, and derivatives of each of these exemplary fibers.

The acrylate component can include, but is not limited to, mono-functional acrylates, di-functional acrylates, tri-functional acrylates, tetra-functional acrylates, and combinations thereof. In addition, the acrylate can include, but is not limited to, water-soluble mono-, di-, and polymethacrylates with a low viscosity. In particular, the acrylate component can include, but is not limited to, 2-hydroxyethyl methacrylate, hydroxypropyl methacrylate, polyethylene glycol monomethacrylates (e.g. molecular weight of about 400), ethylene glycol methacrylate, glycerine monomethacrylate, methyl methacrylate, 2-tert-butylaminomethyl methacrylate, tetrahydrofurfuryl methacrylate, ethyltriglycol monomethacrylate, dimethylaminoethyl methyacrylate, methacrylic acid, polyethylene glycol dimethacrylates (e.g., molecular weight of about 400), glycerine dimethacrylate, ethylene glycol dimethacrylate, triethylene glycol dimethacrylate, urethane methacrylate, bis-EMA (e.g., ethoxylated bisphenol-A-dimethacrylate) as well as polymethacrylates (e.g., homo- and copolymers) of the stated mono- and dimethacrylates. The acrylate component can also include, but is not limited to, metal salts of methacrylate and acrylate. In particular, the acrylate component can include, but is not limited to, sodium methacrylate, potassium methacrylate, ammonium methacrylate, magnesium methacrylate, calcium methacrylate, aluminum methacrylate, zinc methacrylate, zirconium methacrylate, zirconium trihydroxymonomethacrylate, zirconium dihydroxydimethacrylate, sodium acrylate, potassium acrylate, ammonium acrylate, magnesium acrylate, calcium acrylate, aluminum acrylate, zinc acrylate, zirconium acrylate, zirconium trihydroxymonoacrylate, and zirconium dihydroxyacrylate. In addition, the acrylate component can also include, but is not limited to, acrylates having ethylenically unsaturated groups and acid groups (e.g., —COOH) or ethylenically unsaturated groups, acid groups (e.g., —COOH) and structural groups (e.g., —NH₂) in one component. The acrylates having ethylenically unsaturated groups also include the acid esters that can be formed from the above-stated mono- and dimethacrylates.

The reducing agent can include chemicals such as, but not limited to, a water soluble amine, metal salts, hydrazines, and combinations thereof. In particular, the reducing agent can include chemicals such as, but not limited to, dimethyl-ptoluidine, dihydroxyethyl-p-toluidine and N,N-dimethylaminobenzoate, and combinations thereof. The light sensitive initiator can include, but is not limited to, UV initiators and/or visible initiators. The UV initiator can include chemicals such as, but not limited to, a free radical initiator, a cationic initiator, or combinations thereof. The free-radical initiator includes compounds that produce a free radical on exposure to UV radiation. The free-radical is capable of initiating a polymerization reaction. Exemplar free-radical initiators include, but are not limited to, benzophenones (e.g., benzophenone, methyl benzophenone, Michler's ketone, and xanthones), acylphosphine oxide type free radical initiators (e.g., 2,4,6-trimethylbenzoyldiphenyl phosphine oxide (TMPO), 2,4,6-trimethylbenzoylethoxyphenyl phosphine oxide (TEPO), and bisacylphosphine oxides (BAPO's)), azo compounds (e.g., AlBN), benzoins, and bezoin alkyl ethers (e.g., benzoin, benzoin methyl ether and benzoin isopropyl ether). The free-radical initiator can be used alone or in combination with a coinitiator. Co-initiators are used with initiators that need a second molecule to produce a radical that is active in UV-systems. For example, benzophenone uses a second molecule, such as an amine, to produce a reactive radical. A preferred class of coinitiators are alkanolamines such as, but not limited to, triethylamine, methyldiethanolamine and triethanolamine. Suitable cationic initiators include, but are not limited to, compounds that form aprotic acids or Bronsted acids upon exposure to UV light sufficient to initiate polymerization. The cationic initiator used may be a single compound, a mixture of two or more active compounds, or a combination of two or more different compounds (e.g., co-initiators). Exemplary cationic initiators include, but are not limited to, aryldiazonium salts, diaryliodonium salts, triarylsulphonium salts, and triarylselenium salts. The visible radiation initiator can include, but is not limited to, diketones (e.g., camphorquinone, 1,2-acenaphthylenedione, 1H-indole-2,3-dione, 5Hdibenzo[a,d]cycloheptene-10, and 11-dione), phenoxazine dyes (e.g., Resazurin, Resorufin), acylphosphine oxides, (e.g., diphenyl(2,4,6-trimethylbenzoyl) phosphine oxide), and the like.

The ratio of the thickness of the layer of first powder to second powder will be determined from the quantity and composition of the activation fluid, the ability of the two powders to absorb the fluid and the time required to reach a targeted “flowability” in order to properly intermingle the activated binding powder with the powdered build material. While this ratio may vary, many such ratios fall between 1:3 and 3:1. This ratio can also be varied from layer to layer to enable layer-to-layer composition control. In this way, material properties can be varied as desired from layer to layer throughout the object.

Additionally, a volume of the layer of powdered build plus the activating fluid may be matched to an unoccupied volume within the build material layer. Specifically, the volume of the layer of powdered build plus activating fluid may be less than the unoccupied volume within the build material layer. The unoccupied volume in the build material layer will include space between build material particles and, perhaps, porous space within build material particles.

One exemplary embodiment includes a powdered build material include hydrophilic polymer-silicates and a binding powder including polyacrylic acid. In this example, the activation fluid is 81 wt % water, 3 wt % 2-pyrrolidone, 5 wt % liponic ethylene glycol (LEG-1), 3 wt % SURFYNOL 465, and 5 wt % 1,5-pentanediol, and 3 wt % TERGITOL-1,5-s-7. The activation fluid is applied to the binding powder, activating the binding powder by combining with or dissolving the binding powder. The fluid-treated binding powder then penetrates into the powdered build material in order to selectively bind the powdered build material together.

In a second exemplary embodiment, the build material powder includes glass beads, and the binding powder includes polyvinyl alcohol. The activation fluid is 81 wt % water, 3 wt % 2-pyrrolidone, 5 wt % liponic ethylene glycol (LEG-1), 3 wt % SURFYNOL 465, and 5 wt % 1,5-pentanediol, and 3 wt % TERGITOL-1,5-s-7. The activation fluid is applied to the binding powder, activating the binding powder by combining with or dissolving the binding powder. The fluid-treated binding powder then penetrates into the powdered build material in order to selectively bind the powdered build material together.

### Exemplary Process

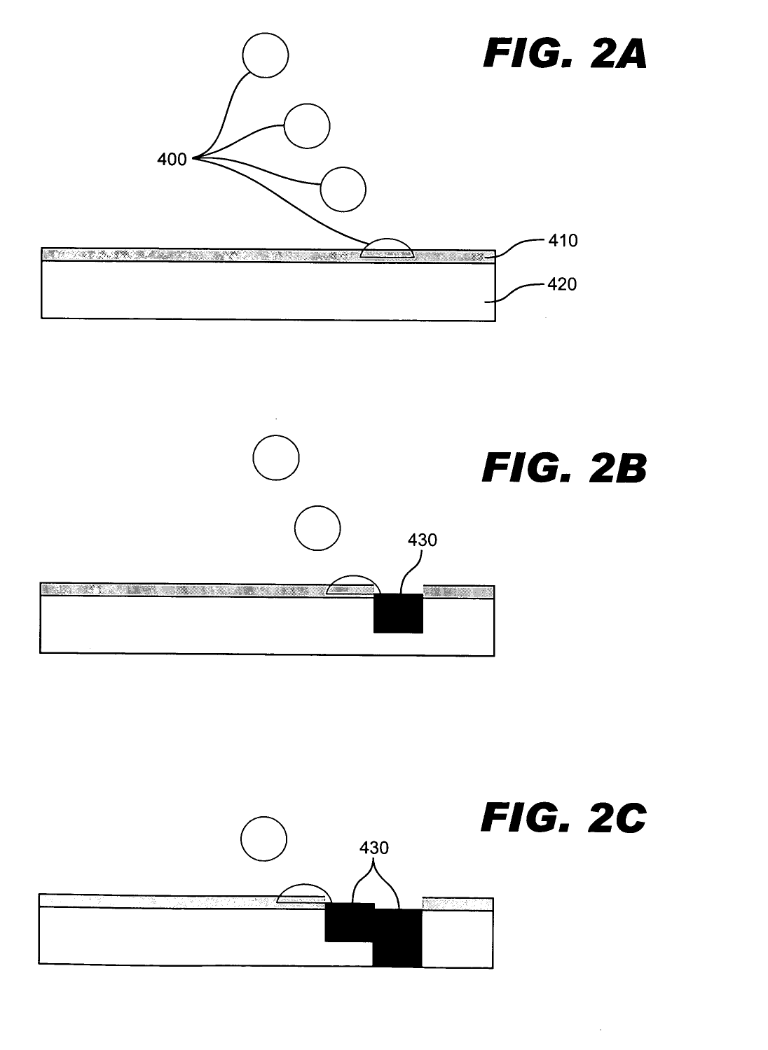

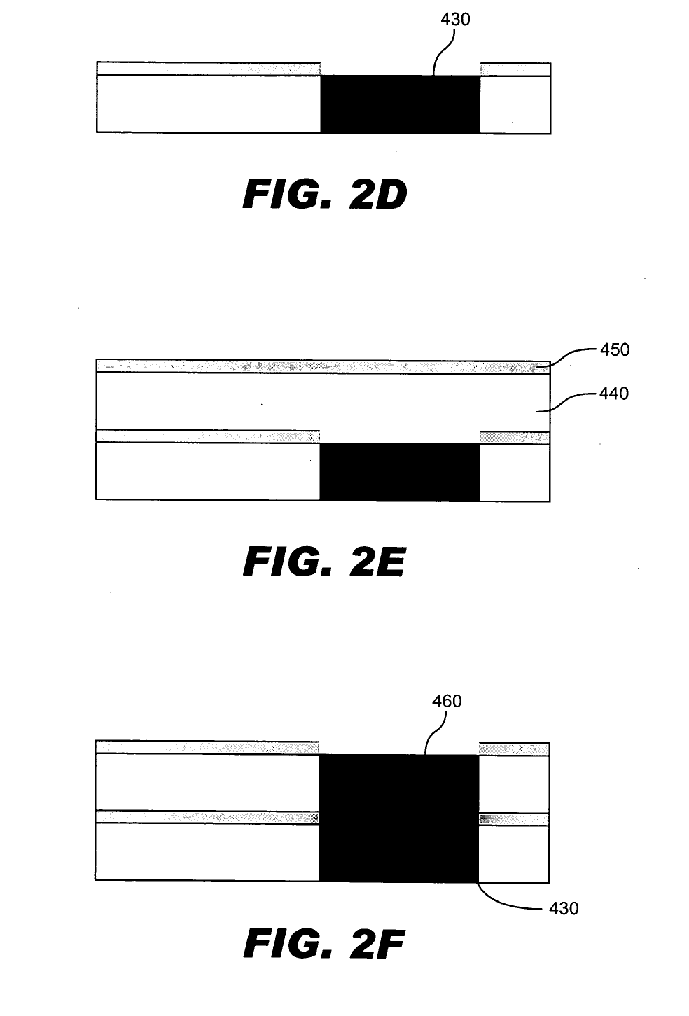

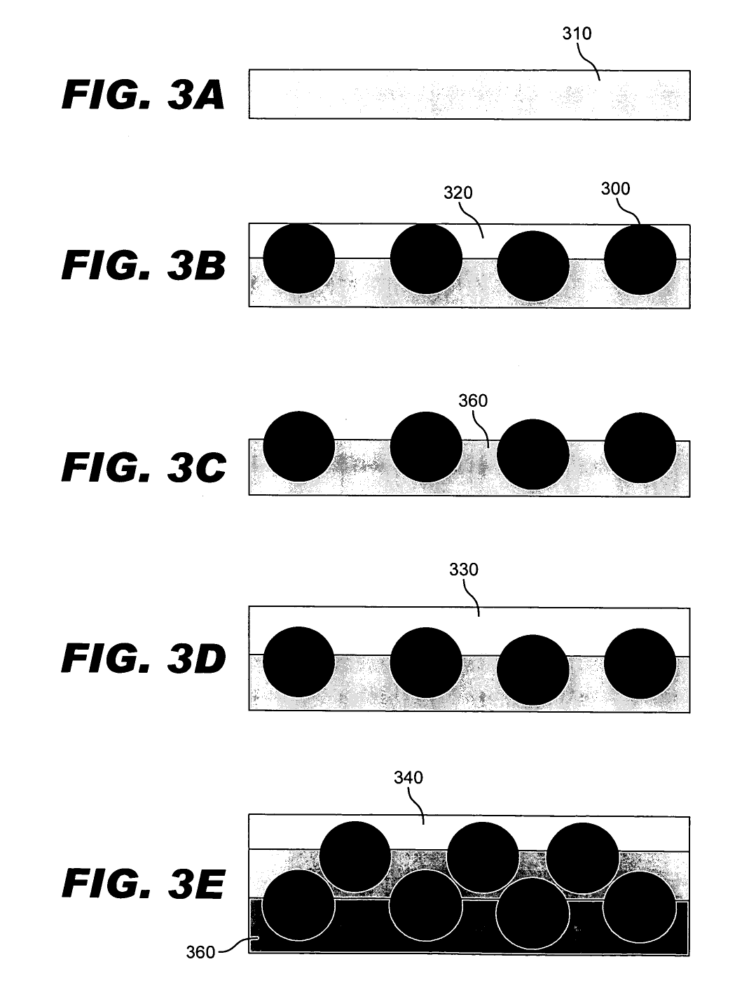

FIGS. 2 and 3, which are each divided into a number of lettered sub-Figs., illustrate various stages in exemplary processes that incorporate the principles described herein for solid freeform fabrication. FIGS. 2 and 3 will be described in the context of, and with references to, the solid freeform fabrication system illustrated in FIGS. 1A and 1 as described above.

As shown in FIG. 2A, and as described above, a layer of powdered build material (420) is dispensed. Then, a layer of binding powder (410) is dispensed over the layer (420) of powdered build material.

After both powder layers have been deposited, the ejection head (150) moves back and forth across the part build bin (160), selectively ejecting activation fluid in a pattern determined by the electronic data defining the object being fabricated. As shown in FIGS. 2A to 2D, drops of the activation fluid (400) dissolve portions of the layer of binding powder (410), which then flows into the underlying layer of powdered build material (420).

As shown in FIG. 2B, the portion of the powdered build material into which the dissolved binding powder penetrates is bound into a portion (430) of the objection being formed. As shown in FIG. 2C, additional drops of activation fluid (400) activate other portions of the binding powder (410) and bind adjacent portions (430) of the layer of build material (420) to form a cross-section of the object being fabricated as shown in FIG. 2D.

While this example describes the activation fluid as dissolving the binding powder, the activation fluid may activate the binding powder in other ways. The activation fluid may also drag binding powder into the powdered build material without dissolving it. The activation fluid may activate a binding powder simply through dissolution or dragging, or through numerous adhesion mechanisms, for example, the acid/structural hardening mechanism, and/or the chemically activated polymerization mechanism. Additional adhesion mechanisms can be used in connection with this process, such as the light activated polymerization mechanism.

The activation fluid used may be selected to optimize layer-to-layer cohesion, and may comprise various solvents such as aqueous and organic solvents. Additives in the activation fluid can be desirable to control the activation of the binding powder and the jettability of the activation fluid, especially in the case of aqueous fluids. The activation fluid may also include ink, i.e., dyes and/or pigment colorants; wetting agents; viscosity modifying agents; humectants and surfactants.

As shown in FIGS. 2E and 2F, the process is repeated, with additional layers of powdered build material (440) and binding powder (450) being deposited. As each layer of the solid freeform object is produced, new layers of powdered build material and binding powder are applied to the part build bin (160, FIG. 1) by first powder roller (130, FIG. 1) and second powder roller (140, FIG. 1). The ejection head (150, FIG. 1) then applies activating fluid as described. The activation fluid is applied to bind the predetermined portions of the new structural layer (460) to the bound portions of the layer below (430). This process is repeated for as many layers as are needed to build up the object being fabricated.

As illustrated in FIGS. 3A-3E, anchor particles can be included in the layers of powder. These anchor particles serve to anchor together different layers of the object being fabricated. The anchor particles can be added to the powdered build material or the binding powder. Alternatively, the anchor particles can be separately distributed between the application of the powdered build material and the binding powder.

In the example shown in FIG. 3A, a layer of powdered build material (310) is first deposited. Then, as shown in FIG. 3B, a layer of binding powder (320) including anchor particles (300) is deposited. The anchor particles (300) are partially pressed into the layer of first powder (310) by the roller that distributes the layer of binding powder (320). Alternatively, the anchor particles (300) can be applied first, with the binding powder (320) being deposited subsequently.

In either case, the activating fluid is then selectively applied, as described above, and dissolves portions of the layer of binding powder (320). The dissolved binding powder then flows into the layer of build material powder (310), leaving the anchor particles (300) protruding from the bound portions of the build material powder (360), as shown in FIG. 3C.

The next layer of powdered build material (330) is then applied as shown in FIG. 3D. The anchor particles protruding from the lower layer of build material (310) will also extend into this next layer of build material (330) as shown in FIG. 3D. When the next layer of build material (330) is bound, the anchor particles (300) will cross-link the two adjacent layers of the object being formed and thereby provide greater mechanical and shear strength in the object. Another layer of binding powder (340), with additional anchor particles (300), is then applied, as shown in FIG. 3E, and the process is repeated.

The anchor particles (300) may be of the same material as the build material powder but with larger particle size. Alternatively, the anchor particles may be of another material that interacts well with the powdered build material and the binding properties of binding powder. Materials from which anchor particles can be selected include, but are not limited to, preformed nanocomposites such as PEO/clay, closite 10A, closite 30B, closite Na+, hydrophilic polymer silicates, hydroxyapatites, and layered double hydroxides (LDHs); fibrous materials such as polypropylene polyimides, and glass; cellulosics; inorganics such as glass, aluminum, and zirconium; metals such as steel, gold, and copper; preformed plastic granules such as polystyrene polymethacrylates, and epoxies. The anchor particles (300) may also be selectively deposited with a powder dispenser (210), to yield variable properties within a single fabricated object.

In some alternative examples, the materials described herein are applied in a slightly different order to conduct the freeform fabrication. For example, after the powdered build material is deposited, the activating fluid is applied selectively and directly to the powdered build material. The activating fluid does not react chemically with the build material in the absence of the binding powder, but will remain on the surface or in the pores of the build material layer.

Then, the binding powder layer is applied as described above, for example, with a powder roller. Where the activating fluid is present on or in the build material layer, the binding powder will dissolve in or otherwise react with the activating fluid to selectively bind those portions of the build material layer to form the desired object.

The separate layers of binding and build material powder described herein allow for the use of an activating fluid that does not itself include the binder that binds together the build material. Consequently, a much wider variety of materials and material combinations can be used, particularly in the binding powder.

In some examples of the principles described herein, a single moving stage or roller may be used to distribute both the powdered build material layer and the binding powder. The single roller embodiment could have a roller with two or more axes of freedom so that it could be positioned and moved to spread either powder. For example, the single roller may include a 90 degree rotation around a Z axis so as to be positioned to spread powder from powder supply bins positioned as shown in FIG. 1. In other examples, the single roller could just translate along one axis with the two powder supply bins being disposed on either side of the build bin.

In past systems, because the binder was ejected from the ejection head, any binder materials used needed to be compatible with the ejection head. In the methods and system described herein, the ejection head need only eject the activation fluid that activates the binding powder. The ejection head does not eject the binder itself. As a result, materials that would be difficult to eject from the ejection head, but have strong binding properties can now be used in the binding powder spread over the powdered build material. For example, a binder with much higher concentrations of polymer or other binding component can be used in the binding powder, avoiding the constraints of high viscosity, low surface tension, or nucleation that apply to materials being delivered through an ejection head.

Additionally, in some previous solid freeform fabrication systems, aggressive fluids have been needed to solubilize binder materials for ejection through the ejection head. Unfortunately, these aggressive fluids have also been known to cause ejection head pens or nozzles to prematurely malfunction due, for example, to electrical shorts, kogation and clogging. The less aggressive activating fluid described herein is less potentially damaging to the ejection head and increases ejection head lifetime by reducing these issues and promoting jetting robustness.

Use of an activating fluid that does not itself comprise the binding factor also avoids excessive wetting of the nozzle plate and thus reduces interference with the direction of emitted drops and reactions with airborne powder. The easier jetting achieved reduces weak, missing, or misdirected nozzles which leads to improved object quality, including dimensional control and part integrity.

The use of two separate powders, with the binding powder not mixed with the build material powder, prevents unintended binding that commonly occurs in single powder systems if the powder container is opened for a period of time prior to use of the powder in a fabrication and thus exposed to ambient moisture or other agents. Unintended binding in single powder binder system can also sometimes occur during shipping or storage prior to opening.

In the system described herein, a wide variety of bulk build materials such as glass, polymers, ceramics, and metals can be used, as the process is compatible with numerous adhesion materials and mechanisms. Additionally, the overall part shear strength may also be increased by the use of anchor particles within or in conjunction with the binding powder.

The preceding description has been presented only to illustrate and describe exemplary embodiments of the system and process. It is not intended to be exhaustive or to limit the system and process to any precise form disclosed. Many modifications and variations are possible in light of the above teaching. It is intended that the scope of the system and process be defined by the following claims.

What is claimed is:

1. A solid freeform fabrication system comprising:
a powdered build material deposited as a layer in a fabrication bin;
a binding powder deposited as a layer over said layer of powdered build material; and
an activating fluid that is selectively dispensed from an ejection head to activate said binding powder;
wherein activated binding powder then selectively binds said build material into a cross-section of an object being fabricated.

2. The system of claim 1, further comprising:
a first roller for spreading said powdered build material into a uniform layer in said fabrication bin; and
a second roller for spreading said binding powder into a layer over said build material.

3. The system of claim 1, further comprising a single roller for spreading said powdered build material into a uniform layer in said fabrication bin and for spreading said binding powder into a layer over said build material.

4. The system of claim 1, wherein said activating fluid is applied selectively to said powdered build material before said binding powder is deposited.

5. The system of claim 1, wherein said activating fluid dissolves said binding powder and carries said dissolved binding powder into said underlying build material to selectively bind said build material to form said object.

6. The system of claim 1, further comprising anchor particles extending between layers of said object to improve mechanical strength of said object.

7. The system of claim 6, wherein said anchor particles are disposed in said binding powder.

8. The system of claim 6, wherein said anchor particles comprise at least one of: preformed nanocomposite, fibrous material, cellulosics, inorganics, metal, preformed plastic granules, epoxy, PEO/clay, closite 10A, closite 30B, closite Na+, hydrophilic polymer silicates, hydroxyapatites, layered double hydroxides (LDHs), polypropylene polyimides, glass, aluminum, zirconium, steel, gold, copper, polystyrene polymethacrylates, epoxies, and any combinations thereof.

9. The system of claim 1, wherein the build material comprises particles that have been treated with a surface treatment to make them more wettable or reactive with said activated binding powder.

10. The system of claim 1, wherein the binding powder comprises at least one of: pyrrolidone, polysaccharides, cellulose derivatives, homopolymers of polyacids, copolymers of polyacids, natural starches, chemically modified starches, polyacrylamides, polyformamides, polyacetamides, polyoxazolidones, polyethylene glycol, polyethylene oxide, poly(2-ethyl-2-oxazoline), sugars, and any combinations thereof.

11. The system of claim 1, wherein the binding powder comprises at least one of: pullulan, chitosan, carrageenan, acacia, polyalginic acid, xantham gums, methyl cellulose, hydroxypropylmethylcellulose, hydroxyethylcellulose, polyacrylic acid, polymethacrylic acid, polyvinylacetic acid, polyitaconic acid, polystyrenesulfonic acid, polyvinyl sulfate, polyvinylphosphonic acid, polymaleic acid, natural wheat starch, natural corn starch, natural rice starch, natural tapioca starch, chemically modified wheat starch, chemically modified corn starch, chemically modified rice starch, chemically modified tapioca starch, sucrose, dextrose, fructose, lactose, polydextrose, sorbitol, xylitol, citric acid, succinic acid, sulfates, phosphates, bentonite, silicates, and any combinations thereof.

12. The system of claim 1, wherein a volume of the layer of powdered build plus said activating fluid is less than an unoccupied volume within said build material layer.

13. The system of claim 1, wherein the powdered build material comprises at least one of: glass, polymer, ceramic, metal, and any combinations thereof.

14. The system of claim 1, wherein said activation liquid is heated prior to ejection from said ejection head.

15. A method of solid freeform fabrication comprising:
depositing a layer of powdered build material in a fabrication bin;
depositing a layer of binding powder over said layer of powdered build material; and
selectively dispensed an activating fluid from an ejection head to activate said binding powder,
wherein activated binding powder then selectively binds said build material into a cross-section of an object being fabricated.

16. The method of claim 15, wherein said activating fluid is applied selectively to said powdered build material before said binding powder is deposited.

17. The method of claim 15, wherein said activating fluid dissolves said binding powder and carries said dissolved binding powder into said underlying build material to selectively bind said build material to form said object.

18. The method of claim 15, further comprising providing anchor particles that extending between layers of said object to improve mechanical strength of said object.

19. The method of claim 15, further comprising varying a ratio of thicknesses of the layer of powdered build material and the layer of binding powder between different layers of said object to vary material properties of said layers of said object.

20. The method of claim 15, further comprising heating said activation liquid in said ejection head.

21. A system of solid freeform fabrication comprising:
means for depositing a layer of powdered build material in a fabrication bin;
means for depositing a layer of binding powder over said layer of powdered build material; and
means for selectively dispensed an activating fluid to activate said binding powder,
wherein activated binding powder then selectively binds said build material into a cross-section of an object being fabricated.

22. The system of claim 21, wherein said activating fluid is applied selectively to said powdered build material before said binding powder is deposited.

23. The system of claim 21, further comprising means for providing anchor particles that extending between layers of said object to improve mechanical strength of said object.
